(19) United States
(12) Patent Application Publication
(10) Pub. No.: US 2016/0106608 A1
(43) Pub. Date: Apr. 21, 2016

(54) TRANSPORTATION APPARATUS FOR PATIENTS

(71) Applicant: Catholic University Industry Academic Cooperation Foundation, Seoul (KR)

(72) Inventor: Young Min OH, Gyeonggi-do (KR)

(73) Assignee: Catholic University Industry Academic Cooperation Foundation, Seoul (KR)

(21) Appl. No.: 14/651,516

(22) PCT Filed: Dec. 9, 2013
(86) PCT No.: PCT/KR2013/011361

§ 371 Date: Sep. 22, 2015

(30) Foreign Application Priority Data
Dec. 11, 2012 (KR) 10-2012-0143525

(51) Int. Cl. A61G 7/10

(52) U.S. Cl. CPC A61G 7/1032; A61G 7/103; A61G 7/1046; A61G 7/1036

(57) ABSTRACT

The present invention relates to a transportation apparatus for patients, which is a transportation apparatus that transfers and moves a patient that is on a main body frame in which the legs thereof are mounted with moving wheels. The present invention includes: a sliding plate that is moved to slide to both sides along the widthwise direction, by a sliding and moving means, on the upper surface of the main body frame; a transport conveyor that is coupled to the upper portion of the sliding plate so as to be moved to slide with the sliding plate, and has a conveyor belt which rotate in the forward direction or reverse direction by a rotating and moving means, after the movement; and an operation unit that is disposed on the front surface of the main body frame in the lengthwise direction so as to operate the sliding plate and the transport conveyor by means of the sliding and moving means and the rotating and moving means. According to the present invention, polytrauma patients, spinalized patients, or the like can be transported swiftly, safely, and conveniently.

### TECHNICAL FIELD

The present invention relates to a transportation apparatus for patients, and more particularly, to a transportation apparatus for patients, which includes a sliding plate installed on an upper part of a main body frame of the transportation apparatus to move in the widthwise direction thereof, and a transport conveyor installed above the sliding plate, wherein the sliding plate is moved in the widthwise direction, and then, a rotating conveyor belt of the transport conveyor moves a patient onto the transportation apparatus, so as to safely and conveniently transport the patient.

### BACKGROUND ART

Ambulances are provided with stretchers for safely transporting critical patients to hospitals. Also, hospitals are provided with stretchers for transporting patients to be variously examined. In general, when a patient is moved from such a stretcher to a bed for patients or a checkup bed, a few people raise and move the patient to the bed or the checkup bed.

However, when the raised and moved patient is a polytrauma patient, a spinalized patient, a pregnant woman, or an excessively overweight patient, the patient may be under stress caused by difficulty in the transportation and be additionally injured.

To address these issues, U.S. Pat. No. 4,087,873 discloses “an apparatus for moving objects”, and Korean Patent Registration No. 10-0519878 discloses “a transportation device for a patient”.

U.S. Pat. No. 4,087,873 and Korean Patent Registration No. 10-0519878 also disclose that a transport conveyor employing a conveyor belt is installed on an upper part of a stretcher as a transportation apparatus. Specifically, Korean Patent Registration No. 10-0519878 discloses that a hydraulic cylinder increases the height of a side of the stretcher equipped with the transport conveyor, to thereby incline the transport conveyor to a side thereof.

However, U.S. Pat. No. 4,087,873 discloses that the transport conveyor is directly installed on the upper part of the stretcher. Thus, referring to FIG. 5, although it is needed to minimize a height difference between a transport conveyor 30 and a bed 25 above which the transport conveyor 30 is moved, the transport conveyor 30 is moved at a predetermined height from the bed 25. Thus, a side of a patient P should be raised. This changes a posture of the patient P, and thus, may physically damage the patient P. Even after the transport conveyor 30 is moved at the predetermined height or higher, the weight of the patient P downwardly presses a conveyor belt of the transport conveyor to be subjected to interference, which may cause malfunction and accident of the transport conveyor 30.

To address these issues, a transport conveyor may be moved on a bed at a low height close to a surface of the bed. In this case, frictional interference occurs between a lower surface of a conveyor belt of the transport conveyor and a sheet of the bed, which may cause malfunction and accident of the transport conveyor.

Referring to FIG. 6, a transport conveyor 30 may be obliquely moved on a bed 25 at a predetermined angle, as disclosed in Korean Patent Registration No. 10-0519878. However, a height difference between the transport conveyor 30 and the bed 25 is needed to prevent interference between an end part of a conveyor belt of the transport conveyor 30 and an upper surface of the bed 25. Thus, this also stresses a patient P.

### DISCLOSURE OF THE INVENTION

### Technical Problem

Accordingly, the present invention is intended to address various issues as described above. An object of the present invention is to provide a transportation apparatus for patients, which includes a sliding plate moving between a transport conveyor and a main body frame of the transportation apparatus in the widthwise direction thereof such that the transport conveyor is moved together with the sliding plate. Thus, interference between the transport conveyor and a bed sheet to which a patient is moved is prevented by the sliding plate, and the transport conveyor is maximally lowered, so that the patient can be safely and conveniently moved to a bed for patients or a checkup bed, or to the transportation apparatus.

### Technical Solution

According to an aspect of the present invention, there is provided a transportation apparatus for patients, which places a patient on a main body frame having legs equipped with moving wheels and which transports the patient, the transportation apparatus including: a sliding plate, which is slid to both sides thereof on an upper surface of the main body frame in the widthwise direction thereof by a sliding and moving means; a transport conveyor, which is coupled to an upper part of the sliding plate so as to slide together with the sliding plate, wherein after the sliding of the transport conveyor, a conveyor belt is rotated forward or reverse by a rotating and moving means; and an operation unit, which is installed on a front surface of the main body frame in the longitudinal direction thereof, so as to operate the sliding plate and the transport conveyor by means of the sliding and moving means and the rotating and moving means.

The transportation apparatus may further include: rail recesses, which are formed at both sides of a lower surface of the sliding plate in the widthwise direction thereof, respectively; and sliding rails, which are installed on an upper part of the main body frame and are coupled to the rail recesses, respectively, to guide the sliding of the sliding plate.

The sliding and moving means may include: latch recesses formed in the widthwise direction in the middle between the rail recesses; a latch gear installed on the upper part of the main body frame to engage with the latch recesses; a sliding decelerator connected to a gear central shaft of the latch gear; and a sliding motor connected to the sliding decelerator and electrically connected to the operation unit.

The transport conveyor may include: rotation shafts connected through bearings to both sides of the upper part of the sliding plate and individually and longitudinally installed; a conveyor belt wound around the rotation shafts to rotate; pulleys installed on end parts of the rotation shafts at both sides thereof; and a rotation belt that connects the pulleys to each other.

The rotating and moving means may include: a conveyor decelerator connected to any one of the rotation shafts; and a conveyor motor connected to the conveyor decelerator and electrically connected to the operation unit.

The operation unit may be a stick-type handle equipped with a trigger and a button, wherein the stick-type handle operates the sliding plate, and the trigger installed at the front side of the stick-type handle, and the button installed on an upper surface of the stick-type handle rotate the conveyor belt of the transport conveyor forward or reverse.

Each of the legs of the main body frame may be folded inward to be in tight contact with a lower surface of the main body frame.

### Advantageous Effects

When a patient is moved to a bed for patients or a checkup bed, or from the bed or the checkup bed to a transportation apparatus for patients according to the present invention, even in the case of bringing a transport conveyor into maximally tight contact with the bed or the checkup bed, a sliding plate below the transport conveyor prevents a conveyor belt from being subjected to interference. Thus, the patient can be safely and conveniently moved to the bed or the checkup bed, or the transportation apparatus.

That is, even when the transport conveyor is moved on the bed at a low height close to the height of the bed, there is no frictional interference between a lower surface of the conveyor belt and a bed sheet, thus decreasing the possibility of malfunction and accident of the transport conveyor.

Since a bed for patients, generally used in a hospital, includes a rigid frame and a cushion mattress disposed on a plate, the sliding plate can tightly contact with an upper surface of the cushion mattress and be moved on the bed in a manner of downwardly pressing the cushion mattress. Thus, the patient is substantially free from physical stress caused by a height difference between the transport conveyor and the bed. Specifically, even when the weight of the patient is applied to the transport conveyor, since the sliding plate disposed below the transport conveyor supports the transport conveyor, the transportation apparatus can normally operate.

Thus, the transportation apparatus can be swiftly moved by a minimum number of people, and a polytrauma patient, a spinalized patient, a pregnant woman, and an excessively overweight patient can be efficiently moved without additionally injuring the polytrauma patient, the spinalized patient, the pregnant woman, and the excessively overweight patient.

### BRIEF DESCRIPTION OF THE DRAWINGS

FIG. 1 is a perspective view illustrating a transportation apparatus for patients according to the present invention.

FIG. 2 is an exploded perspective view illustrating a transport conveyor and a sliding plate of a transportation apparatus for patients according to the present invention.

FIG. 3 is a schematic view illustrating a use state of a transportation apparatus for patients according to the present invention when the transportation apparatus is applied to a typical bed or a checkup bed.

FIG. 4 is a schematic view illustrating a use state of a transportation apparatus for patients according to the present invention when the transportation apparatus is applied to a bed including a cushion mattress.

FIG. 5 is a schematic view illustrating a use state of a transportation apparatus employing a conveyor belt in the related art.

FIG. 6 is a schematic view illustrating a use state of an obliquely used transportation apparatus employing a conveyor belt in the related art.

### BEST MODE FOR CARRYING OUT THE INVENTION

Hereinafter, preferred embodiments of a transportation apparatus for patients according to the present invention will now be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

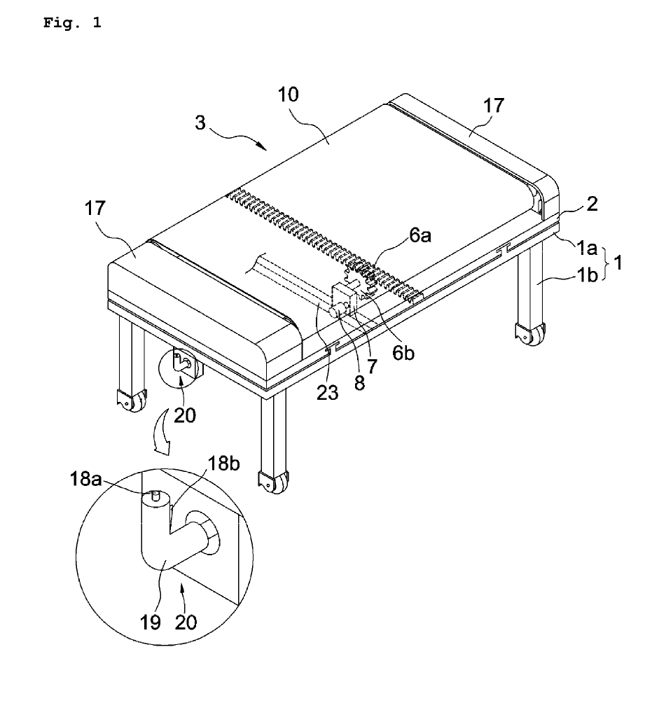

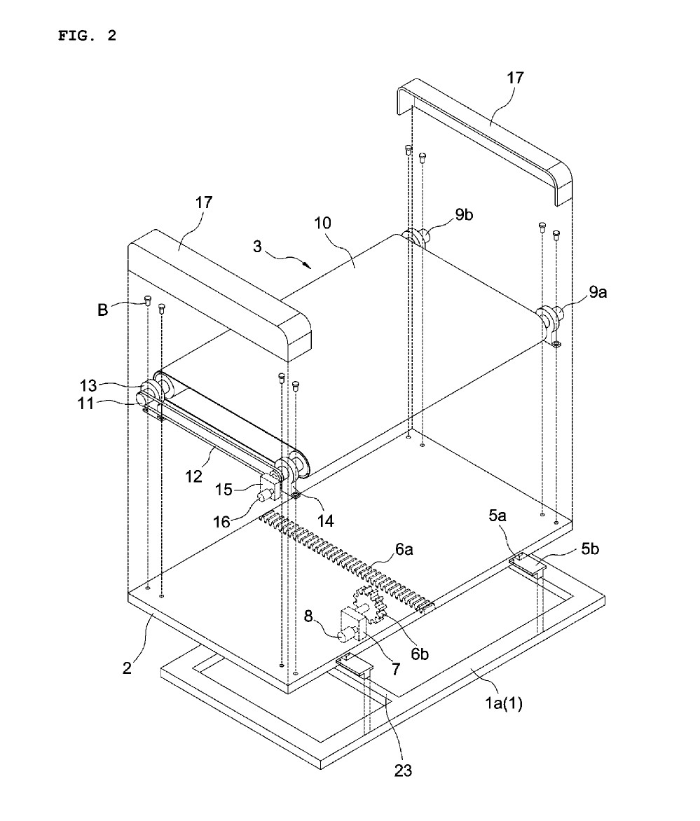

FIG. 1 is a perspective view illustrating a transportation apparatus for patients according to the present invention. FIG. 2 is an exploded perspective view illustrating a transport conveyor and a sliding plate of a transportation apparatus for patients according to the present invention.

Referring to FIGS. 1 and 2, a transportation apparatus for patients according to the present invention includes a sliding plate 2 and a transport conveyor 3, which are installed on a main body frame 1 of a stretcher, and an operation unit 20 installed on a front surface of the main body frame 1 in the longitudinal direction thereof.

Like a typical stretcher, the main body frame 1 may include an upper frame 1a as a rectangular frame having both sides connected to a reinforcement 23, and legs 1b connected to the four corners of the upper frame 1a and equipped with moving wheels 4, respectively, at lower end parts thereof. As in a typical stretcher, respective widthwise parts of the legs 1b may be connected to each other, and the legs 1b may be folded inward to be in tight contact with a lower part of the upper frame 1a. The upper frame 1a may be configured into a plate shape such that legs can be connected to the four corners thereof, respectively. A separate locking device may be installed on the moving wheels 4 to stably stop the moving wheels 4 after a movement of the moving wheels 4.

The upper frame 1a and the legs 1b may be integrated as a single piece into the main body frame 1. In this case, the height of the main body frame 1 can be adjusted.

The sliding plate 2 is installed on the upper frame 1a of the main body frame 1 such that the sliding plate 2 can be moved in a sliding manner to both sides of the main body frame 1 in the widthwise direction thereof by a sliding and moving means. To guide the movement of the sliding plate 2 in the sliding manner, rail recesses 5a are formed in the sliding plate 2, and sliding rails 5b are installed on the main body frame 1. That is, the rail recesses 5a are formed at both sides of a lower surface of the sliding plate 2 in the widthwise direction thereof, respectively, and the sliding rails 5b are inserted in the rail recesses 5a, respectively, to cross an upper end part of the upper frame 1a.

As the sliding and moving means, latch recesses 6a, a latch gear 6b, a sliding decelerator 7, and a sliding motor 8 are individually provided on the main body frame 1 to automatically slide the sliding plate 2 according to a guide of the rail recesses 5a and the sliding rails 5b. The latch recesses 5a are formed in the middle of the lower surface of the sliding plate 2 in the widthwise direction thereof. The latch gear 6b engages with the latch recesses 6a. The sliding decelerator 7 is connected to a rotation shaft at the central part of the latch gear 6b, and a motor shaft of the sliding motor 8 is connected to the sliding decelerator 7. The sliding decelerator 7 and the sliding motor 8 are fixed onto the reinforcement 23 of the upper frame 1a.

The transport conveyor 3 includes rotation shafts 9a and 9b, a conveyor belt 10, pulleys 11, and a rotation belt 12 and is fixed onto the sliding plate 2. The conveyor belt 10 is provided in the form of a wide rectangular plate belt.

The rotation shafts 9a and 9b are installed at both upper sides of the sliding plate 2, and bearings 13 are installed, respectively, at both ends of each of the rotation shafts 9a and 9b, and lower end parts of fixing brackets 14 below the bearings 13 are fixed to the sliding plate 2 by bolts B. Accordingly, the rotation shafts 9a and 9b, which are long, are installed at both sides of the sliding plate 2 in the widthwise direction thereof, respectively. The conveyor belt 10 is wound around the rotation shafts 9a and 9b disposed at both the sides as described above to circulate according to a rotation of each of the rotation shafts 9a and 9b. The pulleys 11 are installed, respectively, on both side end parts of each of the rotation shafts 9a and 9b after the bearings 13, and the pulleys 11 disposed, respectively, at respective end parts of the rotation shafts 9a and 9b, which face each other in the widthwise direction of the sliding plate 2, are connected to each other by the rotation belt 12.

A conveyor decelerator 15 and a conveyor motor 16 are fixed onto the sliding plate 2, as a rotating and moving means for rotating the conveyor belt 10 wound around the rotation shafts 9a and 9b disposed at both the sides as described above. That is, the conveyor decelerator 15 is connected to an end part of the rotation shaft 9a as any one of the rotation shafts 9a and 9b, and a motor shaft of the conveyor motor 16 is connected to the conveyor decelerator 15. Thus, when the rotation shaft 9a is rotated by the conveyor motor 16 and the conveyor decelerator 15, the rotation shaft 9b connected by the pulleys 11 and the rotation belt 12 also rotates, and then, the conveyor belt 10, wound around the rotation shafts 9 and 9a as described above, rotates.

The operation unit 20 is constituted by a stick type handle 19 that is equipped with a trigger 18a and a button 18b. For example, when the stick type handle 19 is inclined right, the sliding plate 2 is moved right. In addition, when the stick type handle 19 is inclined left, the sliding plate 2 is moved left. When the trigger 18a installed at the front side of the stick type handle 19 is pulled, the conveyor belt 10 of the transport conveyor 3 rotates forward. When the button 18b installed on an upper surface of the stick type handle 19 is pushed, the conveyor belt 10 of the transport conveyor 3 rotates reverse. On the contrary, the trigger 18a may rotate the conveyor belt 10 reverse, and the button 18b may rotate the conveyor belt 10 forward.

The bearings 13, the pulleys 11, and the rotation belt 12 are exposed at the end parts of the rotation shafts 9a and 9b of the transport conveyor 3. Thus, protective covers 17 may cover both side end parts of the transport conveyor 3 in the longitudinal direction thereof and be fixed to the sliding plate 2, to protect the bearings 13, the pulleys 11, and the rotation belt 12, and for safety.

Although not shown, the sliding motor 8 and the conveyor motor 16 are electrically connected to the stick type handle 19 of the operation unit 20. Thus, the sliding motor 8 and the conveyor motor 16 are operated by an operation of the stick type handle 19.

A transportation apparatus for patients configured as described above according to the present invention can be applied to a stretcher in any area of a hospital, such as an emergency room, an intensive care room, an operating room, a recovery room, a radiography room, a CT/MRI room, an angiography room, a cardiovascular angiography room, an endoscopic room, and a hemodialysis room, and be applied to stretchers of an ambulance and a helicopter ambulance.

### MODE FOR CARRYING OUT THE INVENTION

Use states of a transportation apparatus for patients configured as described above according to the present invention will now be made in detail.

FIG. 3 is a schematic view illustrating a use state of a transportation apparatus for patients according to the present invention when the transportation apparatus is applied to a typical bed or a checkup bed.

Referring to FIG. 3, when a patient P is moved from a stretcher to a typical bed 21 or a checkup bed, the stick type handle 19 is inclined to a side thereof to move the sliding plate 2 to the typical bed 21 or the checkup bed, whereby the sliding plate 2 is naturally disposed between a side of the patient P and a surface of the typical bed 21 or the checkup bed. That is, the sliding plate 2, an upper part of which is equipped with the transport conveyor 3, is brought into tight contact with the surface of the typical bed 21 or the checkup bed, and simultaneously, the sliding plate 2 and the transport conveyor 3 are moved to be disposed on the typical bed 21 or the checkup bed in a state that the heights of the sliding plate 2 and the transport conveyor 3 are maximally lowered.

After that, the trigger 18a of the stick type handle 19 is pulled to rotate the conveyor belt 10 forward, whereby the patient P disposed on the conveyor belt 10 is naturally moved to the side thereof by means of frictional force of the forwardly rotating conveyor belt 10 and is safely and quickly placed on the typical bed 21 or the checkup bed.

After that, the stick type handle 19 is inclined to another side thereof to move the sliding plate 2 to the transportation apparatus and recover the sliding plate 2.

The sliding plate 2 and the transport conveyor 3 are individually operated as described above. However, the sliding plate 2 and the transport conveyor 3 may be simultaneously operated by inclining the stick type handle 19 right or left and simultaneously pulling the trigger 18a or pressing the button 18b. A moving speed of the sliding plate 2 may be the same as a rotation speed of the conveyor belt 10 of the transport conveyor 3.

On the contrary, when the patient P is moved from the typical bed 21 or the checkup bed to the stretcher, the stick type handle 19 is inclined to the side thereof to move the sliding plate 2 to the typical bed 21 or the checkup bed, whereby the sliding plate 2 is naturally disposed between the side of the patient P and the surface of the typical bed 21 or the checkup bed.

After that, the button 18b of the stick type handle 19 is pushed to rotate the conveyor belt 10 reverse, whereby the patient P disposed on the typical bed 21 or the checkup bed is naturally moved to the transportation apparatus by means of frictional force of the reversely rotating conveyor belt 10 and is safely and quickly placed on the conveyor belt 10 above the transport conveyor 3.

After that, the stick type handle 19 is inclined to another side thereof to move the sliding plate 2 to the transportation apparatus and recover the sliding plate 2 with the patient P placed on the conveyor belt 10.

Also in this case, the sliding plate 2 and the transport conveyor 3 may be simultaneously operated at the same speed by using the stick type handle 19, the trigger 18a, and the button 18b as described above.

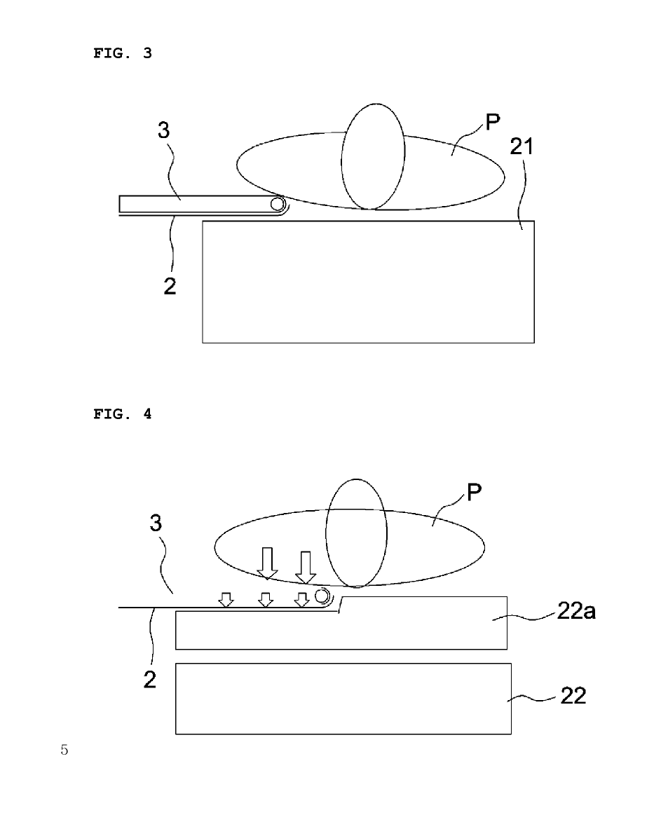

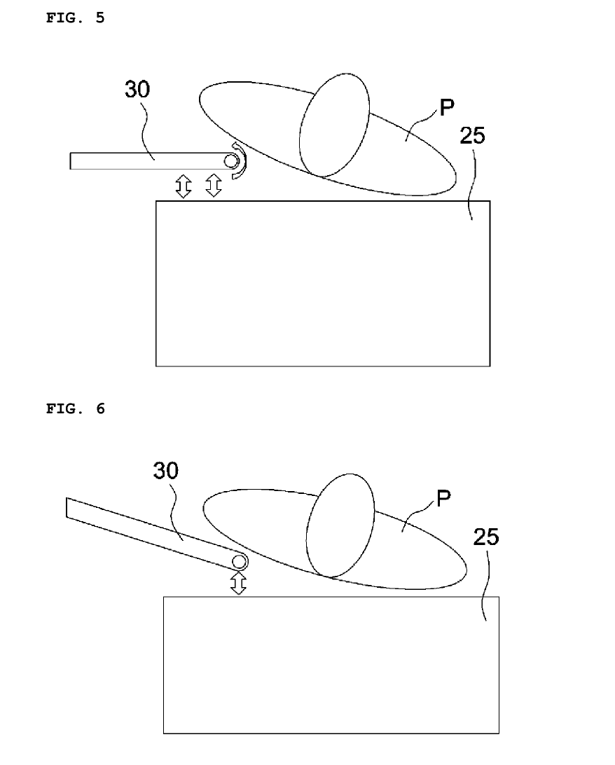

FIG. 4 is a schematic view illustrating a use state of a transportation apparatus for patients according to the present invention when the transportation apparatus is applied to a bed including a cushion mattress.

Referring to FIG. 4, when the patient P is moved to a bed 22 including a cushion mattress 22a, the weights of the sliding plate 2 and the transport conveyor 3 press the cushion mattress 22a, so that the sliding plate 2 and the transport conveyor 3 are maintained substantially at the same height as that of a surface of the bed 22, thus, further efficiently moving the patient P to the bed 22. This is also applied to a case of moving the patient P from the bed 22 to the transport conveyor 3 of the stretcher.

The other use states are substantially the same as that of the case of moving the patient P to the typical bed 21 or the checkup bed, except for the use state of the bed 22 including the cushion mattress 22a.

While the transportation apparatuses for patients according to the present invention have been described with reference to the exemplary drawings, the present invention is not limited to the embodiments and the drawings provided herein, and it will be understood by those skilled in the art that various modifications and changes in form and details may be made without departing from the spirit and scope of the present invention.

### MODE FOR CARRYING OUT THE INVENTION

When a patient is moved to a bed for patients or a checkup bed, or from the bed or the checkup bed to a transportation apparatus according to the present invention, even in the case of bringing a transport conveyor into maximally tight contact with the bed or the checkup bed, a sliding plate below the transport conveyor prevents a conveyor belt from being subjected to interference. Thus, the patient can be safely and conveniently moved to the bed or the checkup bed, or the transportation apparatus.

That is, even when the transport conveyor is moved on the bed at a low height close to the height of the bed, there is no frictional interference between a lower surface of the conveyor belt and a bed sheet, thus decreasing the possibility of malfunction and accident of the transport conveyor.

In addition, the patient is substantially free from physical stress caused by a height difference between the transport conveyor and the bed. Specifically, even when the weight of the patient is applied to the transport conveyor, since the sliding plate disposed below the transport conveyor supports the transport conveyor, the transportation apparatus can normally operate.

1. A transportation apparatus for patients, which places a patient on a main body frame having legs equipped with moving wheels and which transports the patient, the transportation apparatus comprising:
a sliding plate, which is slid to both sides thereof on an upper surface of the main body frame in the widthwise direction thereof by a sliding and moving means;
a transport conveyor, which is coupled to an upper part of the sliding plate so as to slide together with the sliding plate, wherein after the sliding of the transport conveyor, a conveyor belt is rotated forward or reverse by a rotating and moving means; and
an operation unit, which is installed on a front surface of the main body frame in the longitudinal direction thereof, so as to operate the sliding plate and the transport conveyor by means of the sliding and moving means and the rotating and moving means.

2. The transportation apparatus of claim 1, further comprising:
rail recesses, which are formed at both sides of a lower surface of the sliding plate in the widthwise direction thereof, respectively; and
sliding rails, which are installed on an upper part of the main body frame and are coupled to the rail recesses, respectively, to guide the sliding of the sliding plate.

3. The transportation apparatus of claim 2, wherein the sliding and moving means comprises:
latch recesses formed in the widthwise direction in the middle between the rail recesses;
a latch gear installed on the upper part of the main body frame to engage with the latch recesses;
a sliding decelerator connected to a gear central shaft of the latch gear; and
a sliding motor connected to the sliding decelerator and electrically connected to the operation unit.

4. The transportation apparatus of claim 1, wherein the transport conveyor comprises:
rotation shafts connected through bearings to both sides of the upper part of the sliding plate and individually and longitudinally installed;
a conveyor belt wound around the rotation shafts to rotate;
pulleys installed on end parts of the rotation shafts at both sides thereof; and
a rotation belt that connects the pulleys to each other.

5. The transportation apparatus of claim 4, wherein the rotating and moving means comprises:
a conveyor decelerator connected to any one of the rotation shafts; and
a conveyor motor connected to the conveyor decelerator and electrically connected to the operation unit.

6. The transportation apparatus of any one of claims 1 to 5, wherein the operation unit is a stick-type handle equipped with a trigger and a button, wherein the stick-type handle operates the sliding plate, and the trigger installed at the front side of the stick-type handle, and the button installed on an upper surface of the stick-type handle rotate the conveyor belt of the transport conveyor forward or reverse.

7. The transportation apparatus of any one of claims 1 to 5, wherein each of the legs of the main body frame is folded inward to be in tight contact with a lower surface of the main body frame.
